(19) United States
(12) Patent Application Publication
(10) Pub. No.: US 2026/0336620 A1
(43) Pub. Date: Oct. 29, 2026

(54) VEHICLE CONTROL APPARATUS, VEHICLE CONTROL METHOD, AND VEHICLE CONTROL SYSTEM

(71) Applicant: Hitachi Astemo, Ltd., Ibaraki (JP)

(72) Inventors: Naoki SHINOHARA, Ibaraki (JP); Keisuke SUZUKI, Ibaraki (JP); Yasuaki SATO, Ibaraki (JP)

(21) Appl. No.: 19/107,367

(22) PCT Filed: Aug. 18, 2023
(86) PCT No.: PCT/JP2023/029819

§ 371 Date: Feb. 27, 2025

(30) Foreign Application Priority Data
Sep. 1, 2022 (JP) 2022-138911

(51) Int. Cl. B60W 30/18; B60T 8/1755

(52) U.S. Cl. CPC B60W 30/18109; B60T 8/17555; B60W 2520/10

(57) ABSTRACT

A vehicle control apparatus outputs a control instruction for increasing a driving force by a rear motor and reducing the driving force increased by the rear motor when a vehicle stop time becomes zero, when an electric vehicle is decelerated.

### TECHNICAL FIELD

The present invention relates to a vehicle control apparatus, a vehicle control method, and a vehicle control system.

### BACKGROUND ART

PTL 1 discloses a technique that acquires a physical quantity relating to a speed of a vehicle and a physical quantity relating to a requested braking force required to decelerate the vehicle and generates a driving force by a driving device under a state in which a friction braking force is being generated when the vehicle is to be decelerated based on the physical quantity relating to the requested braking force with the aim of suppressing a pitching fluctuation that occurs just before the vehicle stops.

### CITATION LIST

### Patent Literature

PTL 1: Japanese Patent Application Laid-Open No. 2022-056583

### SUMMARY OF INVENTION

### Technical Problem

However, the above-described conventional vehicle control apparatus determines the vehicle stop and reduces the generated driving force when a defined time has elapsed after the vehicle speed falls to or below a predetermined speed after the driving force is generated, thereby incurring such a risk that the braking distance may increase when the actual braking force actually generated on the vehicle is smaller than an estimated total braking force.

One of objects of the present invention is to provide a vehicle control apparatus, a vehicle control method, and a vehicle control system capable of achieving both suppression of a pitching fluctuation when a vehicle stops and suppression of an increase in a braking distance at the same time.

### Solution to Problem

According to one aspect of the present invention, a vehicle control apparatus outputs a control instruction for increasing a driving force by a driving apparatus and reducing the driving force increased by the driving apparatus when a physical quantity relating to a vehicle stop target reaches a reference value,

According to the one aspect of the present invention, both the suppression of the pitching fluctuation when the vehicle stops and the suppression of the increase in the braking distance can be achieved at the same time.

### BRIEF DESCRIPTION OF DRAWINGS

FIG. 1 schematically illustrates an electric vehicle 1 including a vehicle control system according to a first embodiment.

FIG. 2 is a control block diagram of a rear motor 7 according to the first embodiment.

FIG. 3 is a control block diagram of a total braking torque calculation portion 34 according to the first embodiment.

FIG. 4 is a control block diagram of a control gain calculation portion 35 according to the first embodiment.

FIG. 5 is a control block diagram of an added torque calculation portion 37 according to the first embodiment.

FIG. 6 is a control block diagram of a vehicle stop determination portion 54 according to the first embodiment.

FIG. 7 is a control block diagram of a control gain rate limit portion 55 according to the first embodiment.

FIG. 8 illustrates time charts of a vehicle speed, a control gain, and a rear motor torque according to a comparison example.

FIG. 9 illustrates time charts of the vehicle speed, the control gain, and the rear motor torque in anti-jerk control according to the first embodiment.

FIG. 10 illustrates time charts of a motor speed and a vehicle stop time in an expected braking state.

FIG. 11 illustrates time charts of the motor speed and the vehicle stop time when a motor vibrates.

FIG. 12 is a control block diagram of a frictional brake motor 3 according to a second embodiment.

FIG. 13 is a control block diagram of a total braking torque calculation portion 93 according to the second embodiment.

FIG. 14 is a control block diagram of a subtracted braking force calculation portion 94 according to the second embodiment.

FIG. 15 illustrates time charts of the vehicle speed, the control gain, and the rear motor torque in anti-jerk control according to the second embodiment.

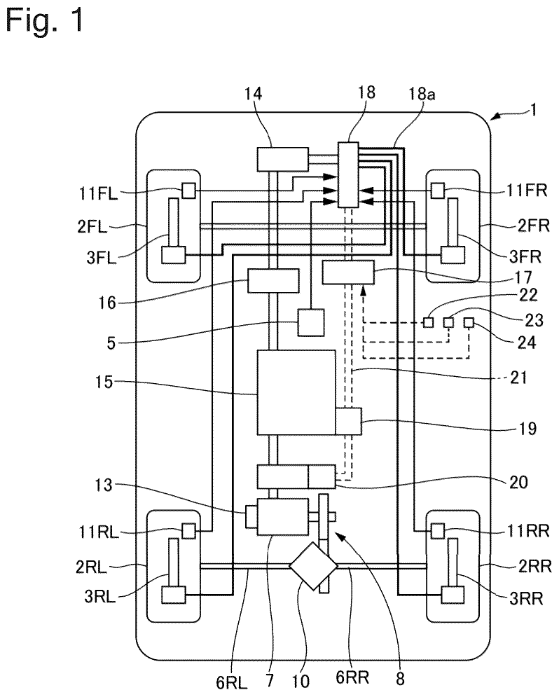

### DESCRIPTION OF EMBODIMENTS

[First Embodiment] FIG. 1 schematically illustrates an electric vehicle 1 including a vehicle control system according to a first embodiment.

The electric vehicle 1 includes front wheels 2FL and 2FR and rear wheels 2RL and 2RR, and frictional brakes (frictional braking apparatuses) 3FL, 3FR, 3RL, and 3RR mounted on the respective wheels and configured to generate frictional braking forces on the respective wheels (hereinafter, the frictional brakes of the respective wheels will also be collectively referred to as a frictional brake 3).

The electric vehicle 1 includes a rear motor (a driving apparatus) 7, which outputs a torque to the rear wheels 2RL and 2RR. The rear wheels 2RL and 2RR will also be collectively referred to as a drive wheel 2. Power is transmitted between the rear motor 7 and the rear wheels 2RL and 2RR via a reducing gear 8, a differential 10, and rear axles 6RL and 6RR.

The wheels 2FL, 2FR, 2RL, and 2RR include wheel speed sensors 11FR, 11FL, 11RL, and 11RR, which detect wheel speeds, respectively. The rear motor 7 includes a rear-wheel resolver 13, which detects a motor speed (a motor rotational speed). Further, the electric vehicle 1 includes a G sensor 5, which detects a longitudinal acceleration (hereinafter also simply referred to as an acceleration) of the vehicle.

The frictional brake 3 generates the braking force based on a frictional force by pressing brake pads against a brake rotor integrally rotating with each wheel in a direction along a rotational axis of each wheel. The frictional brake 3 according to the first embodiment will be described as being configured to press the brake pads using a wheel cylinder actuated by a brake hydraulic pressure, but may be configured to press the brake pads via, for example, a ball screw mechanism driven by an electric motor and is not especially limited.

The electric vehicle 1 includes a low-voltage battery 14 and a high-voltage battery 15. The low-voltage battery 14 is, for example, a lead storage battery. The high-voltage battery 15 is, for example, a lithium ion battery or a nickel hydrogen battery. The high-voltage battery 15 is charged by electric power whose voltage is increased by a DC-DC converter 16.

The electric vehicle 1 includes a vehicle control apparatus (a control portion) 17, a brake control apparatus 18, a rear motor control apparatus 20, and a battery control apparatus 19. These control apparatuses 17, 18, and 20 share information with one another via a CAN bus 21.

The vehicle control apparatus 17 acquires information from various kinds of sensors such as the rear-wheel resolver 13, an accelerator pedal sensor 22, which detects an accelerator operation amount, a brake sensor 23, which detects a brake operation amount, and a gear position sensor 24, and comprehensively controls the vehicle. The vehicle control apparatus 17 outputs a driver request torque that the rear motor 7 should output according to a request distribution torque in response to a request torque according to an accelerator operation, a brake operation, or the like of the driver.

The brake control apparatus 18 acquires information from various kinds of sensors such as the brake sensor 23 to set a target braking torque, which is a torque converted value of a target braking force of the vehicle, to generate the brake hydraulic pressure required for each wheel according to the target braking torque to output it to the frictional brake 3 via a hydraulic pipe 18a.

The battery control apparatus 19 monitors a charged/discharged state of the high-voltage battery 15 and a cell constituting the high-voltage battery 15. The battery control apparatus 19 calculates a battery request torque limit value based on the charged/discharged state of the high-voltage battery 15 or the like. The battery request torque limit value is a maximum torque allowed for the rear motor 7. For example, when the charged capacity of the high-voltage battery 15 is lowered, the battery request torque limit value is set to a smaller value than normal.

The rear motor control apparatus 20 controls electric power to supply to the rear motor 7 based on a rear request torque.

The electric vehicle 1 according to the first embodiment performs anti-jerk control of causing the rear motor 7 to output a driving torque corresponding to a total braking torque determined by estimating a braking torque actually generated on the vehicle when the vehicle stops, with the aim of suppressing an unpleasant vibration of the vehicle when the vehicle stops to thus ease fatigue of a passenger. As a result, a longitudinal jerk (jolt) that occurs when the vehicle stops with a predetermined brake operation amount can be reduced by approximately 68% compared to when the anti-jerk control is absent. In other words, the vehicle can smoothly stop even in the absence of a skillful brake operation.

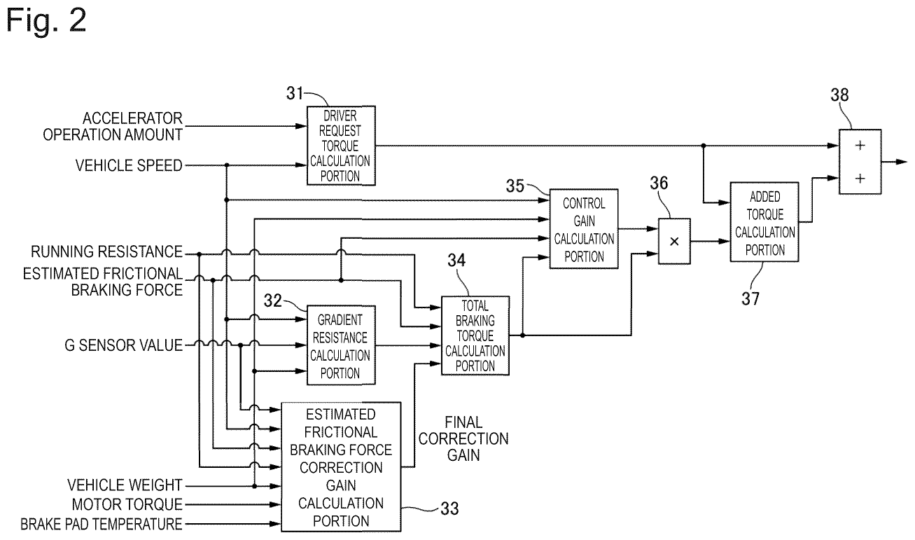

FIG. 2 is a control block diagram of the rear motor 7 according to the first embodiment.

A driver request torque calculation portion 31 calculates the driver request torque based on the accelerator operation amount and a vehicle speed. The wheel speed is determined by any method as appropriate based on each wheel speed detected by each of the wheel speed sensors 11FR, 11FL, 11RL, and 11RR, but is determined by referring to the motor speed detected by the rear-wheel resolver 13 under a low speed.

A gradient resistance calculation portion 32 calculates gradation resistance, which is resistance acting on the vehicle due to a gradient of a road surface, based on the vehicle speed, the G sensor value, and a vehicle weight. More specifically, the gradient resistance calculation portion 32 determines an estimated gradient acceleration generated due to the gradient based on a deviation between a differential value of the vehicle speed and the G sensor value, and calculates the gradient resistance based on the estimated gradient acceleration generated due to the gradient and the vehicle weight.

An estimated frictional braking force correction gain calculation portion 33 calculates a final correction gain for correcting an estimation error of an estimated frictional braking force that occurs along with a change in a pad μ (a frictional coefficient) based on the G sensor value, the vehicle speed, the estimated frictional braking force, a running resistance, the vehicle weight, a motor torque, and a brake pad temperature. When the pad μ changes due to, for example, a temperature change or a humidity change, the estimated frictional braking force deviates from the braking force actually generated on the vehicle by the brake. Therefore, the pad μ is estimated, and a gain for correcting the estimated frictional braking force (a torque converted value thereof) is calculated to cancel out an error in an estimated pad μ from a nominal value of the pad μ.

The estimated frictional braking force is calculated as a sum of the respective estimated frictional braking forces of the wheels. The estimated frictional braking force Bi of each wheel is calculated using the following equation (1).

estimated frictional braking force Bi of each wheel=brake hydraulic pressure×cylinder area×brake effective radius×pad μ (nominal value) (1)

In this case, the nominal value of the pad μ is kept constant while the vehicle is running once it is set. The nominal value is set by acquiring a temperature-μ characteristic of the brake pad as a map in advance and referring to the map. The temperature of the brake pad when the nominal value is calculated may be an external temperature when the vehicle starts running, or a predefined temperature (for example, 20 °C) may be used.

The running resistance may be determined by acquiring a change in the running resistance with respect to a change in the vehicle weight or the vehicle speed in advance and calculating the running resistance based thereon, or estimating the running resistance.

The estimated frictional braking force may be estimated based on a driver's stroke amount of the brake pedal instead of the brake hydraulic pressure.

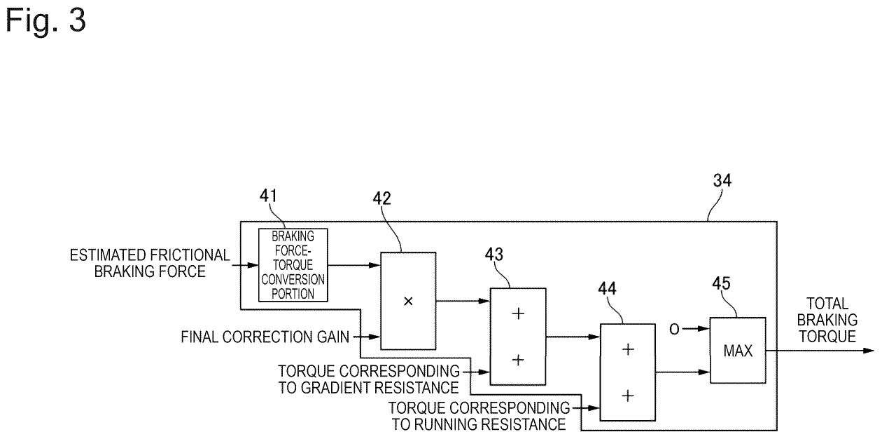

A total braking torque calculation portion 34 calculates the total braking torque based on the running resistance, the estimated frictional braking force, the gradient resistance, and the final correction gain. FIG. 3 is a control block diagram of the total braking torque calculation portion 34 according to the first embodiment. A braking force-torque conversion portion 41 converts the estimated frictional braking force into an estimated frictional braking torque. A multiplier 42 calculates an after-correction estimated frictional braking torque resulting from correcting the estimation error that occurs along with the change in u of the brake pad by multiplying the estimated frictional braking torque by the final correction gain. A first adder 43 and a second adder 44 add a torque corresponding to the gradient resistance and a torque corresponding to the running resistance to the after-correction estimated frictional braking torque. A limiter 45 compares a value resulting from adding the torque corresponding to the gradient resistance and the torque corresponding to the running resistance to the after-correction estimated frictional braking torque, and zero, and outputs one of them that has a larger value as the total braking torque.

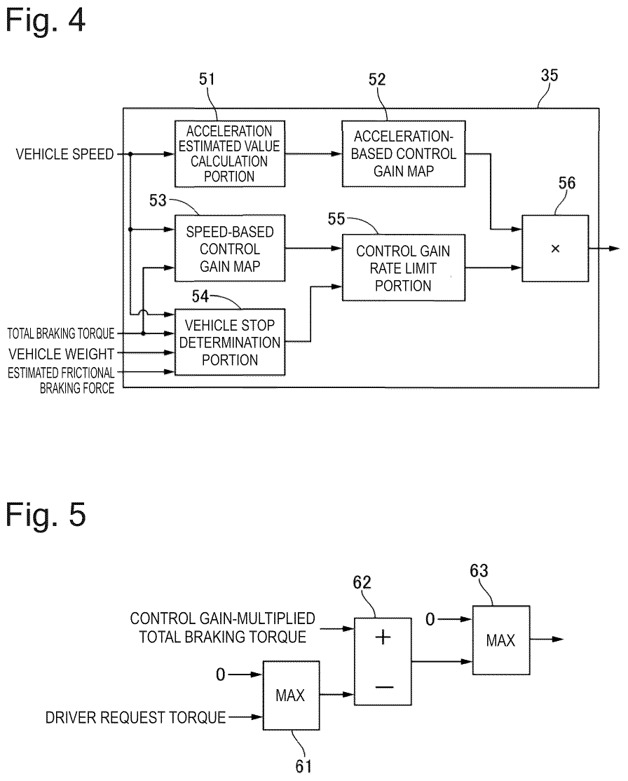

A control gain calculation portion 35 calculates a control gain based on the vehicle speed, the total braking torque, the vehicle weight, and the estimated frictional braking force. FIG. 4 is a control block diagram of the control gain calculation portion 35 according to the first embodiment. An acceleration estimated value calculation portion 51 calculates an acceleration by differentiating the vehicle speed. An acceleration-based control gain map 52 sets an acceleration-based control gain according to the acceleration. The acceleration-based control gain map 52 sets the acceleration-based control gain to 1 (100 %) if a deceleration smaller than a predefined value x2 (G) as the absolute value is generated while gradually reducing the acceleration-based control gain as the absolute value of the deceleration increases if a deceleration equal to or greater than the predefined value x2 (G) as the absolute value is generated. The minimum value of the acceleration-based control gain is set to zero (0%). This setting can prevent the torque from being added at the time of sudden braking. It goes without saying that it is more desirable to secure the braking force than suppressing a vibration in the pitching direction at the time of sudden braking.

A speed-based control gain map 53 sets a speed-based control gain based on a three-dimensional map according to the vehicle speed and the total braking torque. The speed-based control gain has a characteristic of linearly reducing as the total braking torque reduces only in a predetermined region where the total braking torque is around zero, and being kept at a maximum value 1 in most regions exceeding the predetermined region. The maximum value may be set to a positive value different from 1. Further, the speed-based control gain is set so as to linearly increase as the vehicle speed reduces. Further, the speed-based control gain is set in such a manner that a vehicle speed at which the value rises from zero (a gain increase start speed) increases as the total braking torque increases. In other words, the speed-based control gain has such a characteristic that the vehicle speed at which an anti-jerk control instruction intervenes (the vehicle speed at which the generation of a driving force by the anti-jerk control is started) increases as the total braking torque increases.

A vehicle stop determination portion 54 inputs the vehicle speed, the total braking torque, the vehicle weight, and the estimated frictional braking force, and clears a vehicle stop determination flag (=0) unless a vehicle stop time is zero and sets the vehicle stop determination flag (=1) when the vehicle stop time becomes zero. The details of the vehicle stop determination portion 54 will be described below.

A control gain rate limit portion 55 limits the speed of a change in the speed-based control gain on an increase side and a reduction side. Further, when the vehicle stop determination flag is set (=1), the control gain rate limit portion 55 changes the change speed limit value on the reduction side used until that. The details of the control gain rate limit portion 55 will be described below.

A multiplier 56 outputs a value resulting from multiplying the acceleration-based control gain by the speed-based control gain as the final control gain.

Referring back to FIG. 2, a multiplier 36 calculates a control gain-multiplied total braking torque by multiplying the total braking torque by the control gain.

An added torque calculation portion 37 calculates an added torque as an anti-jerk control torque based on the driver request torque and the control gain-multiplied total braking torque. FIG. 5 is a control block diagram of the added torque calculation portion 37 according to the first embodiment. A limiter 61 compares the driver request torque and zero, and outputs one of them that has a larger value. A comparator 62 subtracts the output of the limiter 61 from the control gain-multiplied total braking torque. A limiter 63 compares the output of the comparator 62 and zero, and outputs one of them that has a larger value as the added torque.

An adder 38 sets an after-addition torque resulting from adding the added torque to the driver request torque as the rear request torque.

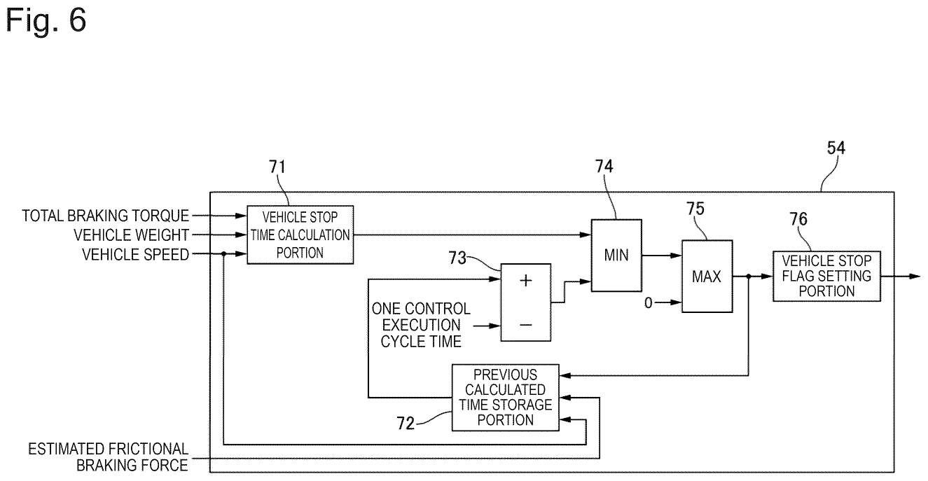

FIG. 6 is a control block diagram of the vehicle stop determination portion 54 according to the first embodiment.

A vehicle stop time calculation portion 71 calculates a vehicle stop time (a vehicle stop target time), which is a time taken until the vehicle stops in each control cycle by referring to a vehicle stop time calculation map (a vehicle stop target time acquisition map) prepared in advance for each vehicle weight based on the vehicle speed and the total braking torque under a speed equal to or lower than a predefined speed. Now, in the anti-jerk control according to the first embodiment, the control gain is determined in association with the vehicle speed and the target braking torque using the speed-based control gain map 53. Therefore, a deceleration change after that can be predicted based on the vehicle speed and the total braking torque. Accordingly, the vehicle stop time calculation map is a map in which the vehicle stop time is set in consideration of the acceleration change after that.

A previous calculated time storage portion 72 stores the vehicle stop time estimated in the previous control cycle, and forgets the previous estimated time when the vehicle speed reaches or exceeds a predefined speed ZI or the estimated frictional braking force becomes zero after the previously calculated vehicle stop time becomes zero or smaller.

Alternatively, the previous calculated time storage portion 72 may be configured to forget the previous estimated time when the estimated frictional braking force falls to or below a predefined value or the pressed brake pedal is returned back by an amount equal to or greater than a predefined value.

A comparator 73 calculates the vehicle stop time in the present control cycle by subtracting one control execution cycle time from the vehicle stop time estimated in the previous control cycle.

A first limiter 74 compares the vehicle stop time calculated by the vehicle stop time calculation portion 71 and the vehicle stop time calculated from the vehicle stop time estimated in the previous control cycle, which is the output of the comparator 73, and outputs one of them that has a smaller value.

A second limiter 75 compares the output of the first limiter 74 and zero, and outputs one of them that has a larger value as a final vehicle stop time.

A vehicle stop flag setting portion 76 clears the vehicle stop determination flag (=0) unless the final vehicle stop time is zero and sets the vehicle stop determination flag (=1) when the final vehicle stop time becomes zero.

Alternatively, the timings of clearing and setting the vehicle stop determination flag may be such timings that the vehicle stop determination flag is set when the vehicle stop time is equal to or shorter than a predefined value and is cleared when the vehicle stop time is equal to or longer than the predefined value, instead of the timings when the time taken until the vehicle stops becomes zero.

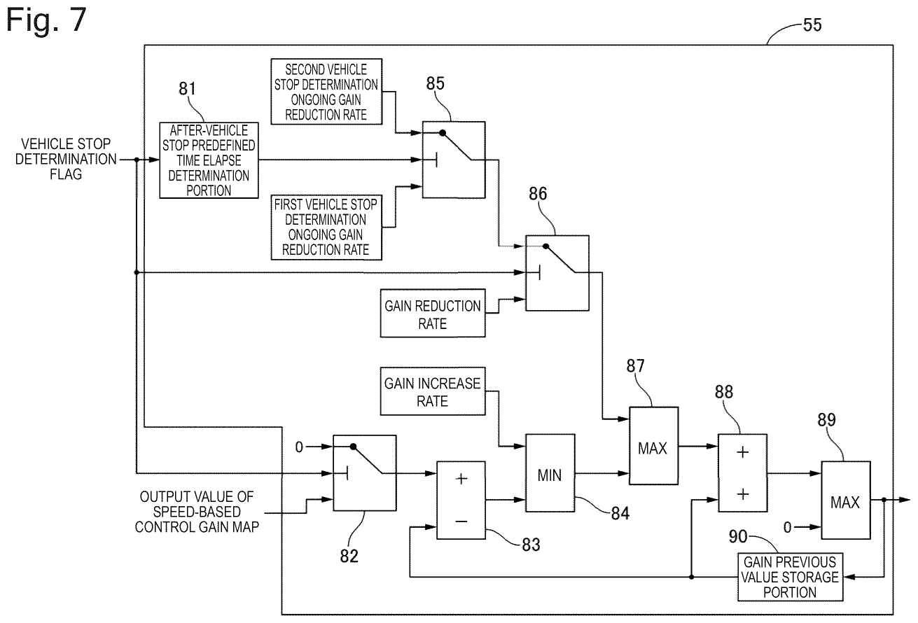

FIG. 7 is a control block diagram of the control gain rate limit portion 55 according to the first embodiment.

An after-vehicle stop predefined time elapse determination portion 81 calculates a time elapsed after the vehicle stop determination flag is set, and clears a predefined time elapse flag (=0) if the predefined time has not elapsed and sets the predefined time elapse flag (=1) if the predefined time has elapsed. A first signal switch 82 outputs the output value of the speed-based control gain map 53 if the vehicle stop determination flag is cleared and outputs zero if the vehicle stop determination flag is set. A comparator 83 outputs a value resulting from subtracting the previous speed-based control gain from the output of the first signal switch 82. A first limiter 84 compares a predefined gain increase rate and the output value of the comparator 83, and outputs one of them that has a smaller value. A second signal switch 85 outputs a first vehicle stop determination ongoing gain reduction rate (a first reduction gradient) if the predefined time elapse flag is cleared, and outputs a second vehicle stop determination ongoing gain reduction rate (a second reduction gradient) if the predefined time elapse flag is set. The second vehicle stop determination ongoing gain reduction rate is set to a value higher than the first vehicle stop determination ongoing gain reduction rate.

A third signal switch 86 outputs a gain reduction rate if the vehicle stop determination flag is cleared, and outputs the output value of the second signal switch 85 (the first vehicle stop determination ongoing gain reduction rate or the second vehicle stop determination ongoing gain reduction rate) if the vehicle stop determination flag is set. A second limiter 87 compares the output value of the third signal switch 86 and the output value of the first limiter 84, and outputs one of them that has a larger value. An adder 88 outputs a value resulting from adding the previous speed-based control gain to the second limiter 87. A third limiter 89 compares the output value of the adder 88 and zero, and outputs one of them that has a larger value as the speed-based control gain.

Now, the control gain rate limit portion 55 may be configured in such a manner that the predefined time of the after-vehicle stop predefined time elapse determination portion 81, the first vehicle stop determination ongoing gain reduction rate, and the second vehicle stop determination ongoing gain reduction rate are not predefined values but change according to, for example, the external temperature or the oil temperature of the suspension. This is because the response characteristic of the suspension changes depending on the oil temperature of the suspension, and this may lead to a change in the return time of the pitch angle of the vehicle generated due to braking and make it impossible to reduce the pitch angle of the vehicle to zero by the time the vehicle stops, thereby causing a shock when the vehicle stops, even if the motor torque is increased. In light thereof, the motor torque is applied for a relatively long time by, for example, increasing the predefined elapsed time or reducing the gain reduction rate (the first vehicle stop determination ongoing gain reduction rate may be set to zero and the gain may be maintained for a predefined time) at the time of, for example, a low temperature under which it is difficult to return the pitch angle. This can increase the time for which an anti-squat force is generated, thereby increasing the time until the pitch angle returns to zero after the vehicle stops, thus contributing to suppressing the shock.

Next, advantageous effects of the first embodiment will be described.

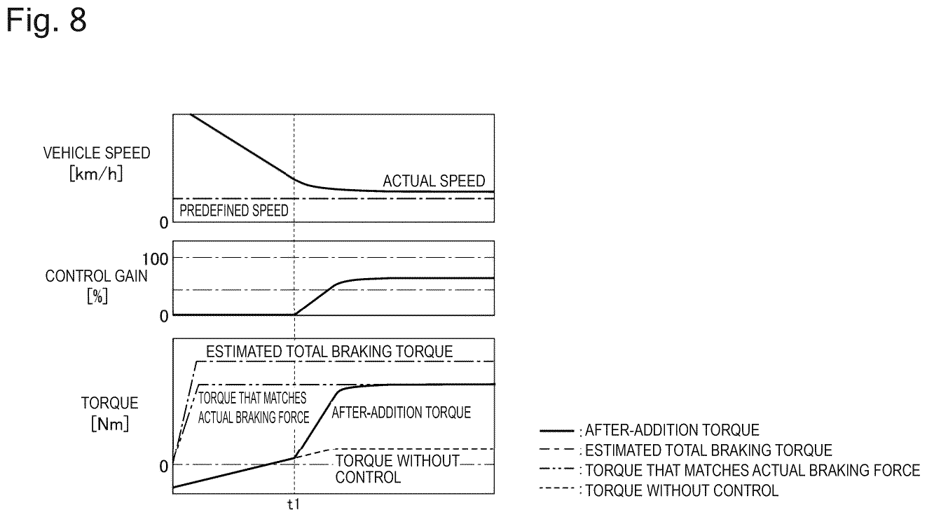

FIG. 8 illustrates time charts of the vehicle speed, the control gain, and the rear motor torque according to a comparison example compared with the first embodiment. In the comparison example, when the vehicle speed falls to or below the predefined speed after the driving force is generated by the anti-jerk control, the vehicle stop is determined after the predefined time has elapsed and the generated driving force is reduced. In this comparison example, an increase in the rear motor torque by the anti-jerk control (the after-addition torque) is started at time t1, but the vehicle speed does not reduce to the predefined speed and the braking distance considerably increases because a torque that matches the actual braking force is smaller than the estimated total braking torque.

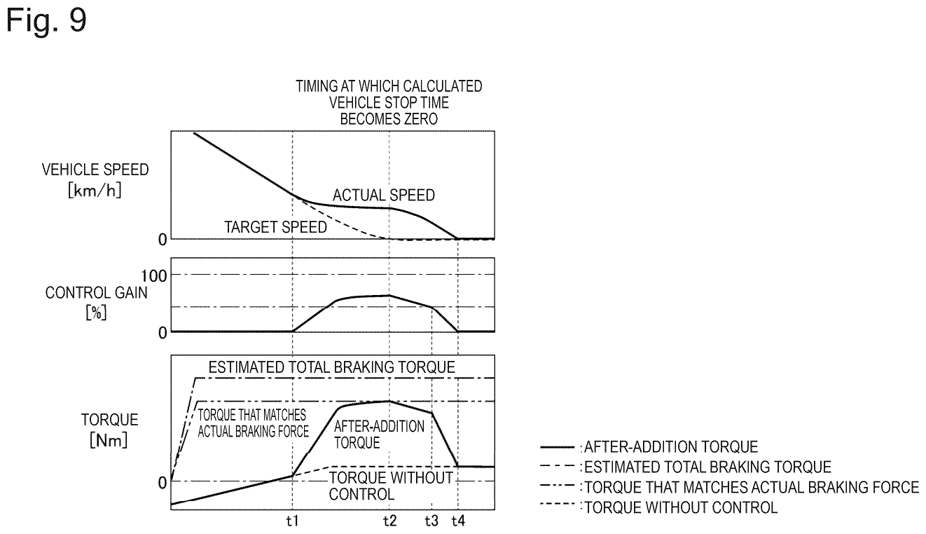

FIG. 9 illustrates time charts of the vehicle speed, the control gain, and the rear motor torque in the anti-jerk control according to the first embodiment.

At time t1, the after-addition torque rises because the vehicle speed reduces to the anti-jerk control intervention speed. The control gain is set to the value resulting from multiplying the output value of the acceleration-based control gain map 52 by the output value of the speed-based control gain map 53, but the highest values of the increase rate and the reduction rate of the speed-based control gain are limited to a predefined gain increase rate and gain reduction rate, respectively.

At time t2, because the vehicle stop time calculated by the vehicle stop time calculation portion 71 becomes zero, the control gain rate limit portion 55 switches the rate of the speed-based control gain from the reduction rate to the first vehicle stop determination ongoing gain reduction rate, and the after-addition torque starts reducing.

At time t3, because the predefined time has elapsed since the vehicle stop time becomes zero, the control gain rate limit portion 55 switches the rate of the speed-based control gain to the second vehicle stop determination ongoing gain reduction rate higher than the first vehicle stop determination ongoing gain reduction rate, and the after-addition torque reduces at a further great gradient.

At time t4, the anti-jerk control is ended.

In this manner, the vehicle control apparatus 17 according to the first embodiment monitors a physical quantity relating to a vehicle stop target, and reduces the rear motor torque when the physical quantity relating to the vehicle stop target reaches a reference value after an increase in the rear motor torque by the anti-jerk control is started. Due to that, even when the actual braking force is smaller than the force corresponding to the estimated total braking torque or even when there is an error in the gradient estimation, the rear motor torque reduces when the vehicle stop target reaches the reference value. As a result, a considerable increase in the braking distance can be suppressed while a pitching fluctuation when the vehicle stops is suppressed. In other words, the vehicle control apparatus 17 according to the first embodiment can achieve both the suppression of a pitching fluctuation when the vehicle stops and the suppression of an increase in the braking distance at the same time.

The first embodiment is constructed assuming that the vehicle stop time taken until the vehicle stops is the physical quantity relating to the vehicle stop target. The speed-based control gain, which determines the rear motor torque, is set according to the vehicle speed and the total braking torque, and therefore a change in the deceleration of the vehicle can be predicted based on the present vehicle speed and the total braking torque and the vehicle stop time can be estimated based on the predicted change in the deceleration.

Then, starting the reduction in the rear motor torque before the vehicle stops may lead to a failure to effectively suppress a pitching fluctuation. On the other hand, determining the timing of starting the reduction in the rear motor torque based on the vehicle speed may lead to an increase in the braking distance. In light thereof, the first embodiment estimates the time taken until the vehicle stops and starts reducing the rear motor torque at the timing when the estimated time taken until the vehicle stops becomes zero (the timing at which the vehicle is considered to stop), thereby being able to effectively achieve both the suppression of a pitching fluctuation and the suppression of an increase in the braking distance at the same time.

The first embodiment acquires the vehicle stop time based on the vehicle stop time calculation map prepared in advance, into which the vehicle speed and the total braking torque are input. Because the vehicle stop time according to the vehicle speed and the total braking torque can be actually measured in advance by an experiment or the like, the calculation load and the calculation time can be reduced by storing it in the form of a map.

A plurality of vehicle stop time calculation maps is prepared in advance according to the vehicle weight. Because the vehicle stop time depends on the vehicle weight, the vehicle stop time can be further accurately estimated regardless of the vehicle weight by preparing the vehicle stop time calculation map according to each vehicle weight.

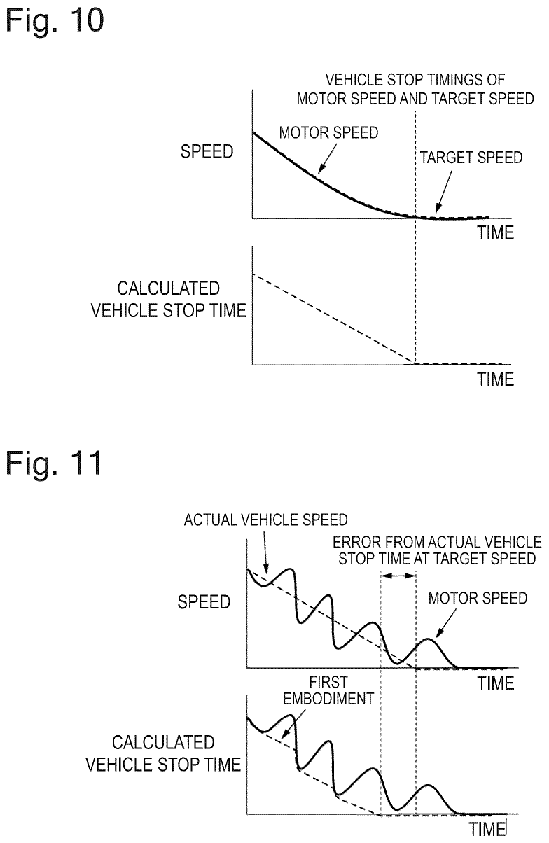

The vehicle control apparatus 17 outputs the control instruction so as to gradually increase the reduction gradient of the torque, when reducing the rear motor torque. More specifically, the vehicle control apparatus 17 outputs the control instruction for reducing the rear motor torque at the first vehicle stop determination ongoing reduction rate for the predetermined time (the predefined time) and reducing the rear motor torque at the second vehicle stop determination ongoing reduction rate higher than the first vehicle stop determination ongoing reduction rate after the predetermined time has elapsed. Now, in the first embodiment, the vehicle control apparatus 17 refers to the motor speed as the vehicle speed when the vehicle speed is a low speed. Therefore, when the vehicle is in an expected braking state as illustrated in FIG. 10, the vehicle stop timings of the motor speed and the target speed match each other and the reduction in the rear motor torque can be started at an optimum timing. On the other hand, when the motor vibrates as illustrated in FIG. 11, it is difficult to distinguish the motor vibration and an actual change in the vehicle speed. In the first embodiment, when a motor speed corresponding to a vehicle speed higher than the actual speed is detected due to a motor vibration, the vehicle stop time is determined by selecting lower one of the previously calculated vehicle stop time and the presently calculated vehicle stop time to suppress an increase in the braking distance. This involves such a risk that the reduction in the torque is started earlier than the actual vehicle stop timing, impairing the effect of the anti-jerk control. In this regard, in the first embodiment, after the calculated vehicle stop time becomes zero, the vehicle control apparatus 17 applies the lower torque reduction rate for the predetermined time and applies the higher reduction rate after the predetermined time has elapsed, thereby being able to prevent the effect of the anti-jerk control from being impaired even when the reduction in the torque is started earlier than the actual vehicle stop timing.

[Second Embodiment] A second embodiment has a basic configuration similar to the first embodiment, and therefore will be described focusing on only differences from the first embodiment.

A vehicle control system according to the second embodiment performs anti-jerk control of reducing the frictional braking force from a frictional braking force serving as a reference (a reference frictional braking force) with the aim of suppressing an unpleasant vibration of the vehicle when the vehicle stops and easing passenger's fatigue. The reference frictional braking force here is an estimated frictional braking force estimated based on the stroke amount of the brake pedal.

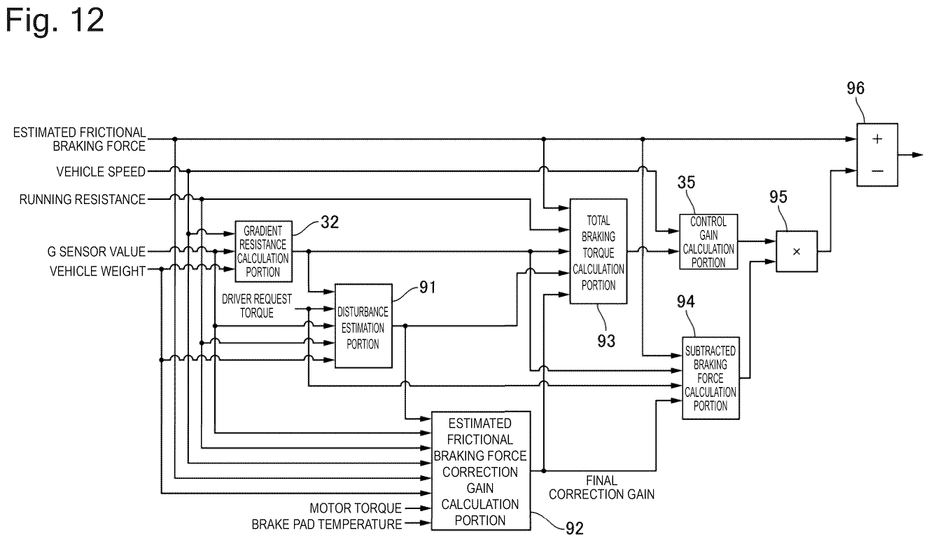

FIG. 12 is a control block diagram of the frictional brake 3 according to the second embodiment.

A disturbance estimation portion 91 estimates a disturbance based on the gradient resistance, the driver request torque, the G sensor value, the running resistance, and the vehicle weight. The disturbance is estimated using the following equation (2) basically when the brake is not in use.

disturbance=G sensor value×vehicle weight−braking/driving force corresponding to driver request torque−gradient resistance−running resistance (2)

The frictional brake 3 may be configured to estimate the disturbance even when the influence of the change in the pad μ is small, such as when the estimated frictional braking force is extremely small.

An estimated frictional braking force correction gain calculation portion 92 calculates the final correction gain for correcting the estimation error of the estimated frictional braking force that occurs along with the change in the pad μ (the frictional coefficient) based on the disturbance, the G sensor value, the running resistance, the vehicle speed, the estimated frictional braking force (the reference frictional braking force), the vehicle weight, the motor torque, and the brake pad temperature. The estimated frictional braking force correction gain calculation portion 92 calculates the final correction gain by a similar method to the estimated frictional braking force correction gain calculation portion 33 according to the first embodiment, but further takes an error derived from the disturbance to calculate the estimated frictional braking force correction gain.

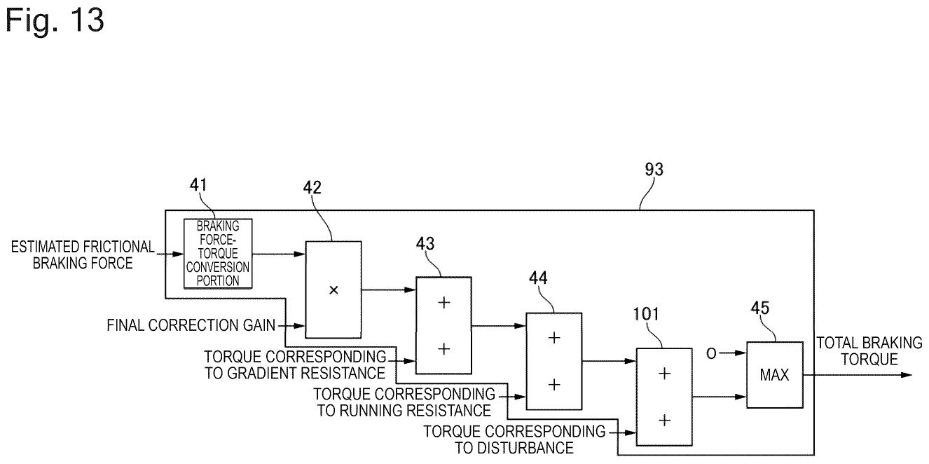

A total braking torque calculation portion 93 calculates the total braking torque based on the estimated frictional braking force, the running resistance, the gradient resistance, the disturbance, and the final correction gain. FIG. 13 is a control block diagram of the total braking torque calculation portion 93 according to the second embodiment. A third adder 101 adds a torque corresponding to the disturbance to the value resulting from adding the torque corresponding to the gradient resistance and the torque corresponding to the running resistance to the after-correction estimated frictional braking torque.

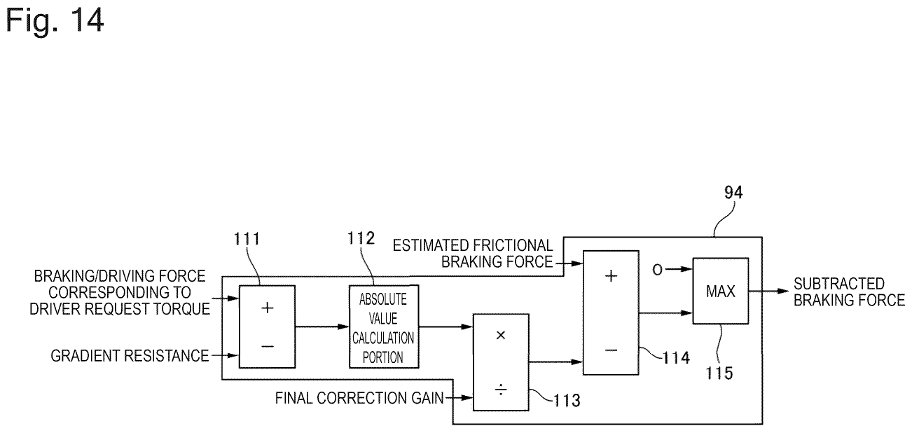

A subtracted braking force calculation portion 94 calculates a subtracted braking force based on the estimated frictional braking force, the disturbance, the driver request torque, and the final correction gain. FIG. 14 is a control block diagram of the subtracted braking force calculation portion 94 according to the fourth embodiment. A comparator 111 calculates a braking/driving force corresponding to the driver request torque in consideration of the gradient resistance by subtracting the gradient resistance from the braking/driving force corresponding to the driver request torque. An absolute value calculation portion 112 calculates an absolute value of the output of the comparator 111. A multiplier 113 calculates a driving force absolute value corresponding to an after-correction driver request torque by dividing the output of the absolute value calculation portion 112 by the final correction gain. A comparator 114 subtracts the driving force absolute value corresponding to the after-correction driver request torque from the estimated frictional braking force. A limiter 115 compares a value resulting from subtracting the driving force absolute value corresponding to the after-correction driver request torque from the estimated frictional braking force, and zero, and outputs one of them that has a larger value as a subtracted braking force.

A multiplier 95 calculates a control gain-multiplied subtracted braking force by multiplying the subtracted braking force by the control gain. A comparator 96 calculates an after-subtraction frictional braking force by subtracting the control gain-multiplied subtracted braking force from the estimated frictional braking force. The brake control apparatus 18 sets an after-subtraction frictional braking torque, which is a torque converted value of the after-subtraction frictional braking force, as a target frictional braking torque.

Next, advantageous effects of the second embodiment will be described.

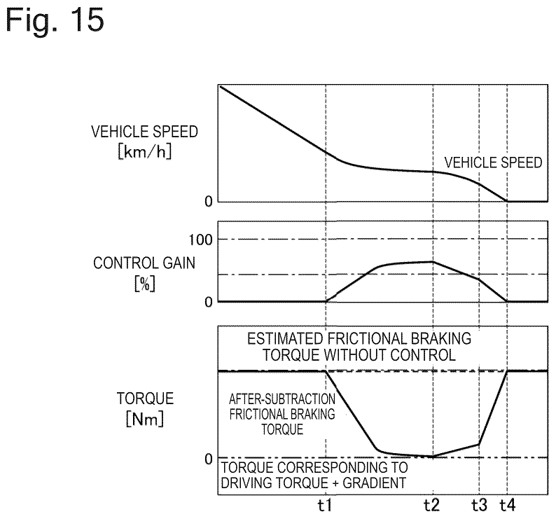

FIG. 15 illustrates time charts of the vehicle speed, the control gain, and the rear motor torque in the anti-jerk control according to the second embodiment.

At time t1, a reduction in the after-subtraction braking torque is started because the vehicle speed reduces to the anti-jerk control intervention speed.

At time t2, because the vehicle stop time calculated by the vehicle stop time calculation portion 71 becomes zero, the control gain rate limit portion 55 switches the rate of the speed-based control gain from the reduction rate to the first vehicle stop determination ongoing reduction rate, and the after-subtraction frictional braking torque starts increasing.

At time t3, because the predefined time has elapsed since the vehicle stop time becomes zero, the control gain rate limit portion 55 switches the rate of the speed-based control gain to the second vehicle stop determination ongoing gain reduction rate higher than the first vehicle stop determination ongoing gain reduction rate, and the after-subtraction frictional braking torque increases at a further great gradient.

At time t4, the anti-jerk control is ended.

In this manner, the vehicle control apparatus 17 according to the second embodiment monitors the vehicle stop time, and increases the frictional braking torque when the vehicle stop time becomes zero after the reduction in the frictional braking torque by the anti-jerk control is started. At this time, the vehicle control apparatus 17 outputs the control instruction for increasing the frictional braking torque at the first vehicle stop determination ongoing reduction rate for the predetermined time (the predefined time) and increasing the frictional braking torque at the second vehicle stop determination ongoing reduction rate higher than the first vehicle stop determination ongoing reduction rate after the predetermined time has elapsed. As a result, the second embodiment can achieve both the suppression of a pitching fluctuation when the vehicle stops and the suppression of an increase in the braking distance at the same time, similarly to the first embodiment.

[Other Embodiments] Having described the embodiments for implementing the present invention, the specific configuration of the present invention is not limited to the configurations of the embodiments, and the present invention also includes a design modification and the like thereof made within a range that does not depart from the spirit of the present invention, if any.

The embodiments have been described citing the example in which the present invention is applied to the rear-wheel drive electric vehicle, but the present invention may also be applied to a front-wheel drive electric vehicle or a four-wheel drive electric vehicle. Further, without being limited to the electric vehicle, the present invention may also be applied to a vehicle equipped with an engine that is an internal combustion engine, or a hybrid vehicle runnable using both an engine and a motor. In other words, the present invention can be applied to any configuration capable of providing a torque from a drive source side or any configuration capable of reducing frictional brake within a range in which the vehicle can stop or a range in which a braking force works between a drive wheel and a road surface when the vehicle stops using the frictional brake.

The estimated frictional braking force is fed as the input in the embodiments, but the estimated frictional braking torque may be input because the braking force and the braking torque are convertible values using a vehicle parameter such as the effective radius of the tire, and the effective radius of the tire at this time may be estimated instead of being a predefined value.

Further, the output in the first embodiment is yielded as the driving torque, but the output may be the driving force, which is a convertible value using the tire effective radius similarly to the relationship between the braking force and the braking torque, or may be the longitudinal acceleration or the longitudinal jerk convertible using a vehicle parameter such as the vehicle weight.

Further, the output in the second embodiment is yielded as the frictional braking force, but may be the frictional braking torque because they are convertible values using the effective radius of the tire or the like, or may be the longitudinal acceleration or the longitudinal jerk convertible using a vehicle parameter such as the vehicle weight.

In the first and second embodiments, the speed-based control gain map may be configured in such a manner that the speed-based control gain map is prepared for each vehicle weight and an appropriate map is selected.

The physical quantity relating to the vehicle stop target may be a distance or a speed without being limited to the time taken until the vehicle stops.

The vehicle weight may be detected by a sensor such as a height sensor of the suspension or may be estimated.

As the brake pad temperature, the temperature of the brake pad may be acquired using a sensor, or a change in the pad temperature may be estimated per time.

In the second embodiment, the disturbance may be estimated by detecting how much the road surface is roughened using a stereo camera or the like. Further, the vehicle control apparatus 17 may be configured to subtract the braking force earlier than the intervention for the braking torque applied under normal conditions, if an increase in the disturbance is expected due to the road surface after the condition of the road surface is detected using the stereo camera or the like.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-138911 filed on Sep. 1, 2022. The entire disclosure of Japanese Patent Application No. 2022-138911 filed on Sep. 1, 2022 including the specification, the claims, the drawings, and the abstract is incorporated herein by reference in its entirety.

### REFERENCE SIGNS LIST

1 electric vehicle (vehicle)
3 frictional brake (frictional braking apparatus)
7 rear motor (driving apparatus)
17 vehicle control apparatus (control portion)

1. A vehicle control apparatus mounted on a vehicle, the vehicle including a frictional braking apparatus configured to generate a frictional braking force on the vehicle and a driving apparatus configured to generate a driving force on the vehicle, the vehicle control apparatus comprising:
a control portion configured to output a result calculated based on input information,
the control portion being configured to
acquire a physical quantity relating to a speed of the vehicle,
acquire a physical quantity relating to a total braking force for decelerating the vehicle,
acquire a physical quantity relating to a vehicle stop target of the vehicle based on the physical quantity relating to the speed of the vehicle and the physical quantity relating to the total braking force, and
output a control instruction for increasing the driving force by the driving apparatus and reducing the driving force increased by the driving apparatus when the physical quantity relating to the vehicle stop target reaches a reference value, or output a control instruction for reducing the frictional braking force from a reference frictional braking force by the frictional braking apparatus and increasing the frictional braking force reduced by the frictional braking apparatus when the physical quantity relating to the vehicle stop target reaches the reference value, at the time of deceleration of the vehicle based on the physical quantity relating to the total braking force.

2. The vehicle control apparatus according to claim 1, wherein the control portion outputs the control instruction for increasing the driving force by the driving apparatus and reducing the driving force increased by the driving apparatus when the physical quantity relating to the vehicle stop target reaches the reference value, at the time of the deceleration of the vehicle based on the physical quantity relating to the total braking force.

3. The vehicle control apparatus according to claim 1, wherein the physical quantity relating to the vehicle stop target is a vehicle stop target time taken until the vehicle stops.

4. The vehicle control apparatus according to claim 3, wherein the reference value is set to a time at which the vehicle stop target time becomes zero.

5. The vehicle control apparatus according to claim 4, wherein the vehicle stop target time is acquired based on a vehicle stop target time acquisition map prepared in advance, into which the physical quantity relating to the speed of the vehicle and the physical quantity relating to the total braking force are input.

6. The vehicle control apparatus according to claim 5, wherein a plurality of the vehicle stop target time acquisition maps is prepared in advance according to a weight of the vehicle,

7. The vehicle control apparatus according to claim 1, wherein the control portion outputs the control instruction so as to gradually increase a reduction gradient of the driving force when reducing the driving force increased by the driving apparatus, or outputs the control instruction so as to gradually increase an increase gradient of the frictional braking force when increasing the frictional braking force reduced by the frictional braking apparatus.

8. The vehicle control apparatus according to claim 7, wherein the control portion outputs the control instruction so as to reduce the driving force at a first reduction gradient for a predetermined time and reduce the driving force at a second reduction gradient greater than the first reduction gradient after the predetermined time has elapsed when reducing the driving force increased by the driving apparatus, or outputs the control instruction so as to increase the frictional braking force at a first increase gradient for the predetermined time and increase the frictional braking force at a second increase gradient greater than the first increase gradient after the predetermined time has elapsed when increasing the frictional braking force reduced by the frictional braking apparatus.

9. The vehicle control apparatus according to claim 1, wherein the control portion outputs the control instruction for reducing the frictional braking force from the reference frictional braking force by the frictional braking apparatus and increasing the frictional braking force reduced by the frictional braking apparatus when the physical quantity relating to the vehicle stop target reaches the reference value, at the time of the deceleration of the vehicle based on the physical quantity relating to the total braking force.

10. A vehicle control method configured to be performed by a control unit mounted on a vehicle, the vehicle including a frictional braking apparatus configured to generate a frictional braking force on the vehicle and a driving apparatus configured to generate a driving force on the vehicle, the vehicle control method comprising:
causing the control unit to
acquire a physical quantity relating to a speed of the vehicle;
acquire a physical quantity relating to a total braking force for decelerating the vehicle;
acquire a physical quantity relating to a vehicle stop target of the vehicle based on the physical quantity relating to the speed of the vehicle and the physical quantity relating to the total braking force; and
output a control instruction for increasing the driving force by the driving apparatus and reducing the driving force increased by the driving apparatus when the physical quantity relating to the vehicle stop target reaches a reference value, or output a control instruction for reducing the frictional braking force from a reference frictional braking force by the frictional braking apparatus and increasing the frictional braking force reduced by the frictional braking apparatus when the physical quantity relating to the vehicle stop target reaches the reference value, at the time of deceleration of the vehicle based on the physical quantity relating to the total braking force.

11. A vehicle control system comprising:
a frictional braking apparatus configured to generate a frictional braking force on a vehicle;
a driving apparatus configured to generate a driving force on the vehicle; and
a control apparatus configured to output a result calculated based on input information, the control apparatus being configured to
acquire a physical quantity relating to a speed of the vehicle,
acquire a physical quantity relating to a total braking force for decelerating the vehicle,
acquire a physical quantity relating to a vehicle stop target of the vehicle based on the physical quantity relating to the speed of the vehicle and the physical quantity relating to the total braking force, and
output a control instruction for increasing the driving force by the driving apparatus and reducing the driving force increased by the driving apparatus when the physical quantity relating to the vehicle stop target reaches a reference value, or output a control instruction for reducing the frictional braking force from a reference frictional braking force by the frictional braking apparatus and increasing the frictional braking force reduced by the frictional braking apparatus when the physical quantity relating to the vehicle stop target reaches the reference value, at the time of deceleration of the vehicle based on the physical quantity relating to the total braking force.
